(19) United States
(12) Patent Application Publication
(10) Pub. No.: US 2013/0179185 A1
(43) Pub. Date: Jul. 11, 2013

(54) SYSTEM AND METHOD FOR TACTICAL MEDICAL TRIAGE DATA CAPTURE AND TRANSMISSION

(71) Applicants: Michael J. Duffy, Fairport, NY (US); Robert E. Daminski, JR., Rochester, NY (US); Jessica G. LaRocque, Bedford, MA (US)

(72) Inventors: Michael J. Duffy, Fairport, NY (US); Robert E. Daminski, JR., Rochester, NY (US); Jessica G. LaRocque, Bedford, MA (US)

(73) Assignee: HARRIS CORPORATION, Melbourne, FL (US)

(21) Appl. No.: 13/347,066

(22) Filed: Jan. 10, 2012

(51) Int. Cl. G06Q 50/24

(52) U.S. Cl. 705/3

(57) ABSTRACT

A method for creating and transmitting electronic medical data from a remote location, such as a battlefield, to a remotely located central data facility. The method can begin by entering the personal identification data for an injured person into a portable handheld computer. Responsive to voice commands, data input fields are selected and populated. The data can be inputted into the computer via a touch screen or via the microphone. A recording may be made, with a camera included in the portable handheld computer, of imagery associated with the injured person. Thereafter, an audio recording can be made, recording audio records concerning injuries or treatments of the injured person. Medical data obtained about the injury, as well as patient vitals are associated to form an electronic medical record. The electronic medical record, along with images and audio, is then transmitted over a communications network to update the central database.

### BACKGROUND OF THE INVENTION

1. Statement of the Technical Field

The invention concerns the real-time collection of medical data in a war theater setting and the transmission of that data to a medical database for both storage and use by rear echelon medical personnel to treat incoming wounded warfighters.

2. Description of the Related Art

The Theater Medical Data Store (TMDS) is a database containing medical records for military service members. It serves as the authoritative theater database for collecting, distributing and viewing the pertinent medical information of service members and provides one central location for health care providers to view theater medical data. TMDS views and tracks ill or injured patients as they move through the theater levels of care. Using TMDS, medical staff can view a critically injured warfighter's history, progress notes, laboratory, drug and radiological history before arrival at their next location. TMDS supports the collection of information from a first responder, battalion aid stations and in-theater hospitals and makes the information readable in-theater and in follow-up facilities in the continental US. AHLTA-T is another database that may store data records before they are transferred to TMDS.

When a warfighter is injured in the theater of battle, there are several methods currently in use for moving data from the battlefield into the TMDS/AHLTA-T system. In its simplest form, the battlefield medic may fill out form DD1380 (Field Medical Card). This form collects basic information regarding injury, illness and treatment during combat and at the site of injury. The form is filled out by an attending medic and is physically attached to the warfighter's body or clothing with a wire or string. A major problem is that these cards are often lost or damaged as the warfighter is transferred to a rear echelon care facility, resulting in the loss of data regarding injuries and treatment received on the battlefield. Thus, the data never makes it to the TMDS system, and the warfighter will need to be reassessed at the care facility, causing delays in treatment. Furthermore, information about treatment or medications already administered by the first responder is lost.

The Symbol device manufactured by Motorola (MC-70) running the Battlefield Medical Information System—Telemedicine (BMIST) operating software or AHLTA-M software provides an electronic means for collecting the data which would have formerly been recorded on the field medical card. The MC-70 device is a hand-held point-of-care assistant that enables military medical care providers to record, store, retrieve and transmit essential elements of patient encounters in an operational setting.

The MC-70 device presents several challenges to an in-theater user. First, it requires extensive training to use in the field, having a non-intuitive user interface, and requires significant manual entry of data with a stylus. Therefore, the medic needs to use both hands to enter any kind of data into the device. Second, the data transfer from the device to the TMDS system requires a physical USB tethering to a networked computer. In this sense, MC-70 device is not much of an improvement over the field medical card, in that the data may not make it back to the battalion aid station or other care facility before the patient. Moreover, in the event that the device is lost or the medic fails to reach a network computer to upload the data, the data may be lost forever.

### SUMMARY OF THE INVENTION

The Tactical Medical Triage System contains an edge device which can provide near real time updates of data to the TMDS system. Data can be captured by the device in the form of videos, still images, audio and text records. The device may be operated with a voice driven capability to simplify data entry by the on-site medic or corpsman There is also an intuitive touchscreen interface available. The system moves data using already implemented tactical and/or commercial infrastructure., thereby enabling the information regarding the injured warfighter to arrive at the battalion aid station or other rear echelon care facility prior to the arrival of the warfighter.

More particularly, a system and method of the present invention involves creating and providing an electronic medical record from a field location (e.g. a battlefield) to a remotely located central data facility. Although the primary purpose of the system and method is for recording the treatment of injured warfighters in a battlefield situation, the system and method also may have applicability in other situations or emergencies that occur in non-battlefield situations, for example, routine first responder situations, traffic accidents, natural disasters and terrorist attacks.

The method can begin by obtaining the personal identification data for the injured person, either by swiping a Common Access Card (CAC) through a card reader accessory, by manually entering the data on site, or by selecting the person from a pre-populated list of persons which have been pre-loaded onto the device or are accessible by the device over a communications network. Responsive to a voice command entered via a microphone on the portable handheld computer, or a tactile input, the user selects the type of data to be entered. In a preferred embodiment, the user has a choice of four selections, including inputting audio, inputting image/video, creating a quick data record, or creating a complete data record. These selections may be made in any order. The input of data is made via a touch screen or a microphone. Once all the data has been input the software forms an electronic medical record which is then transmitted over a communications network.

The invention can also include a system for providing an electronic medical record from a field location to a remotely located central data facility. The invention includes a non-transitory machine readable storage having stored thereon a computer program for execution on a portable handheld computer for providing the functions outlined above. The computer program is arranged to provide an electronic medical record from a battlefield location to a remotely located central data facility in accordance with the method described above.

### BRIEF DESCRIPTION OF THE DRAWINGS

Embodiments will be described with reference to the following drawing figures, in which like numerals represent like items throughout the figures, and in which:

FIG. 1 is an architecture diagram of the components of the tactical medical triage system;

FIG. 2 is a schematic diagram of the device and its communication link via the tactical radio to a portal which can relay the data to the TMDS; and

FIG. 3 contains sample screens which will be utilized by a user of the device to facilitate data entry and other operations of the device.

FIG. 4 is a flow chart that is useful for understanding a method in accordance with the present invention.

FIG. 5 is a drawing that is useful for understanding a hardware architecture for a tactical triage device as described herein.

### DETAILED DESCRIPTION

The present invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

Exemplary embodiments of the invention are explained in the context of obtaining medial treatment information from the battle theater into the TMDS or AHLTA-T database, although, as explained above, the invention may also find use in non-battlefield situations. Additionally, the use of the term “TMDS database” is meant in an exemplary context only; any applicable database, such as the AHLTA-T database, may be used, and the invention is not meant to be limited thereby

The most pressing need is to capture accurate medical data for an injured warfighter in-theater at the time of the encounter and forward the captured data to a treatment facility for use by doctors before the patient arrives. Therefore, it would be desirable to provide a device that can provide a real time update to the TMDS database such as to enable more effective treatment of the injured warfighter and as a side benefit, to accelerate the time line for determination of line of duty benefits to warfighters injured in theater.

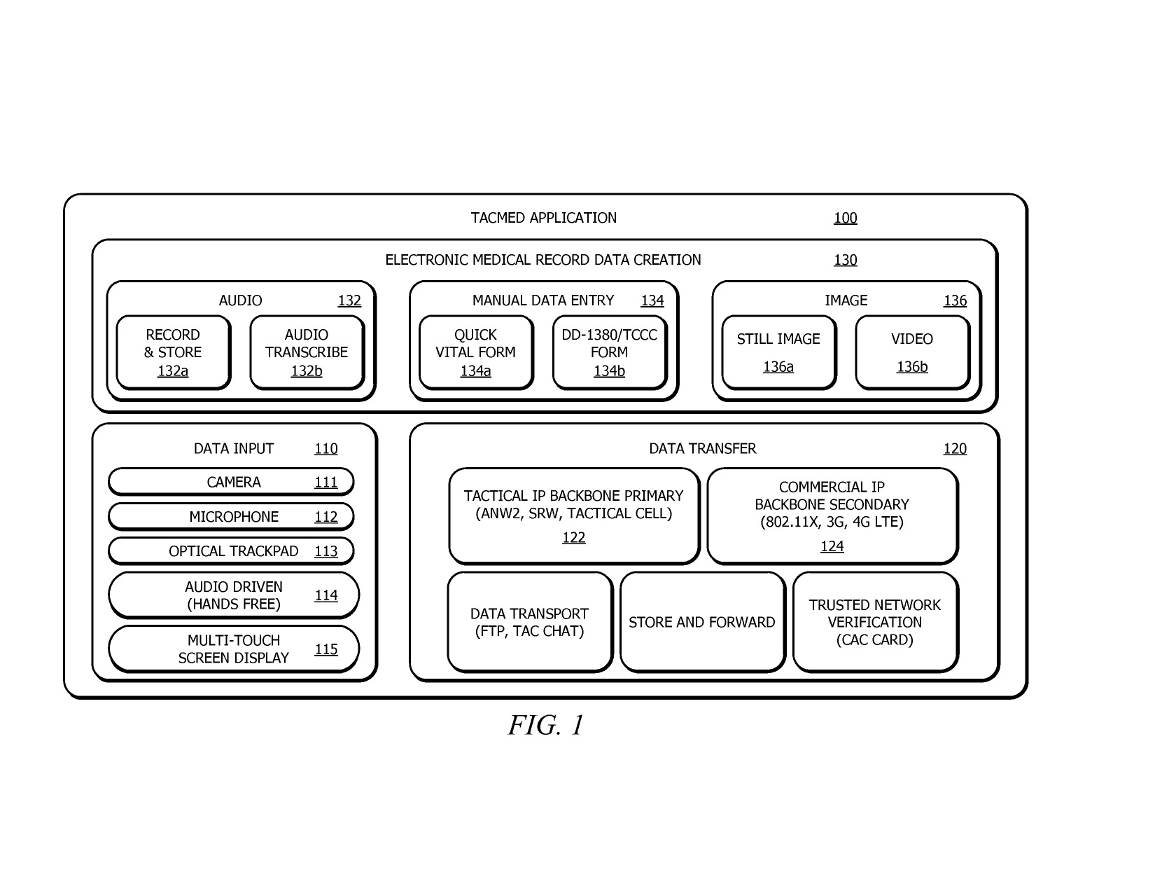

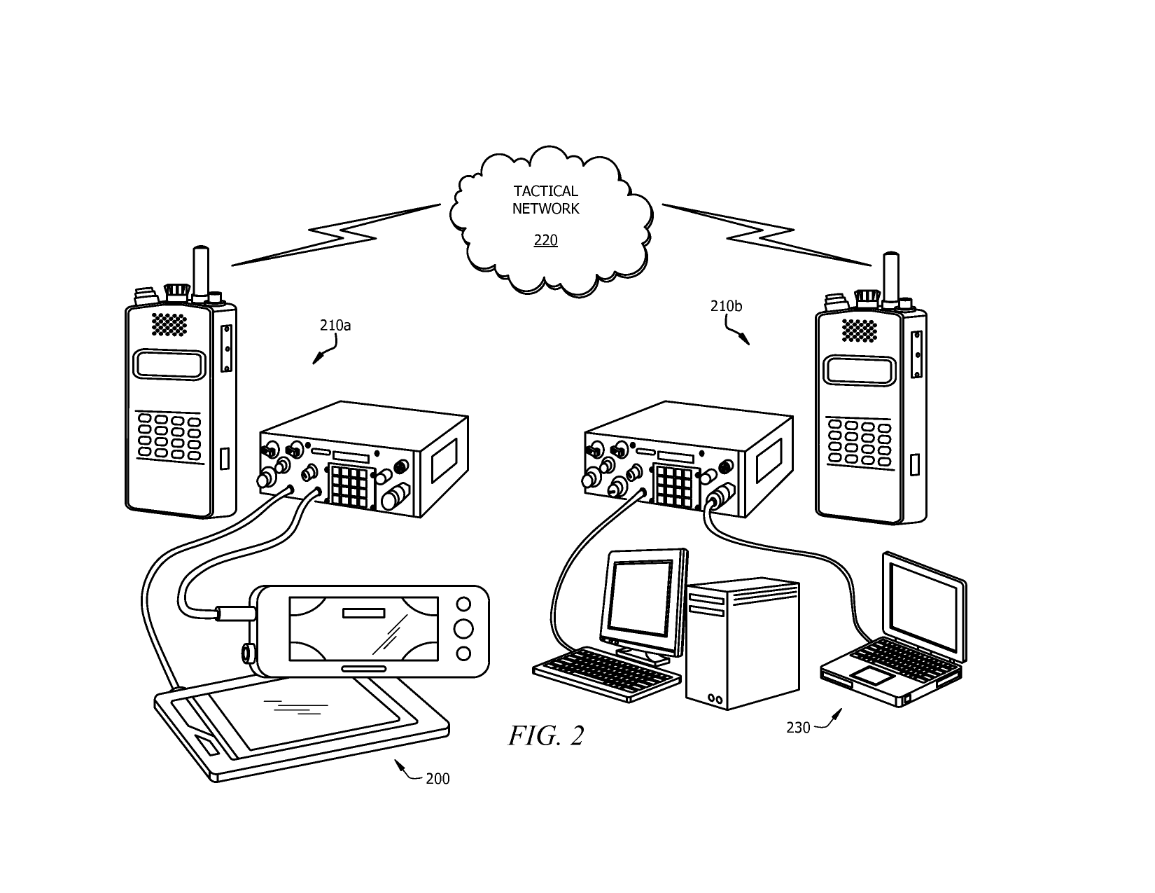

FIG. 1 shows the basic architecture of a tactical medical application 100, which would run on an already existing computer hardware platform. For example, the tactical triage application can be designed to run on an Android platform, such as a smartphone or a computing pad device running the Android operating system. The invention however is not meant to be limited to implementations on the Android platform. Implementations on other smart phone platforms such as iPhone or Blackberry, a tablet computing device, such as an iPAD, or a custom hardware platform, are also contemplated to be within the scope of the invention. The tactical triage application running on a computer hardware platform as described shall sometimes be referred to herein as a tactical triage device.

Box 110 represents the various hardware-supported means of inputting data which will be used both to operate the tactical triage device and to input the data which will become part of the electronic medical record. The hardware supported means can include one or more data input devices. For example, in an embodiment of the invention, the data input devices are standard data input devices which are commonly found in many smartphone and handheld computing tablet devices. As such, hardware modifications are not necessary to operate the application on a typical computer hardware platform. In an embodiment of the invention, the hardware supported means of input include a camera 111 for taking both still images and video, a microphone 112 for accepting both voice commands and audio entry of data, an optical trackpad 113 or other touch device, an audio driver 114, which allows the entry of commends to the device via audio input, and a multi-touch screen display 115. Those skilled in the art will appreciate that hardware configurations having more or fewer input devices are also possible.

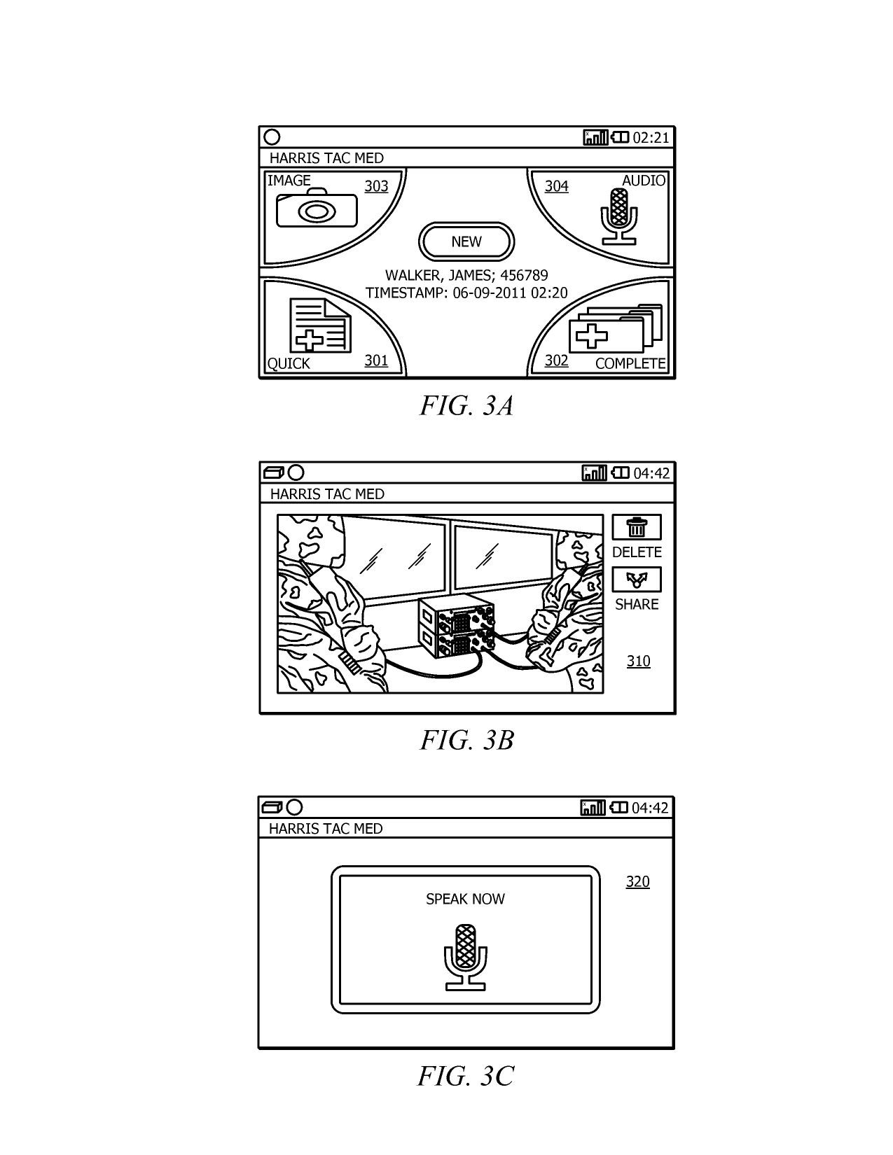

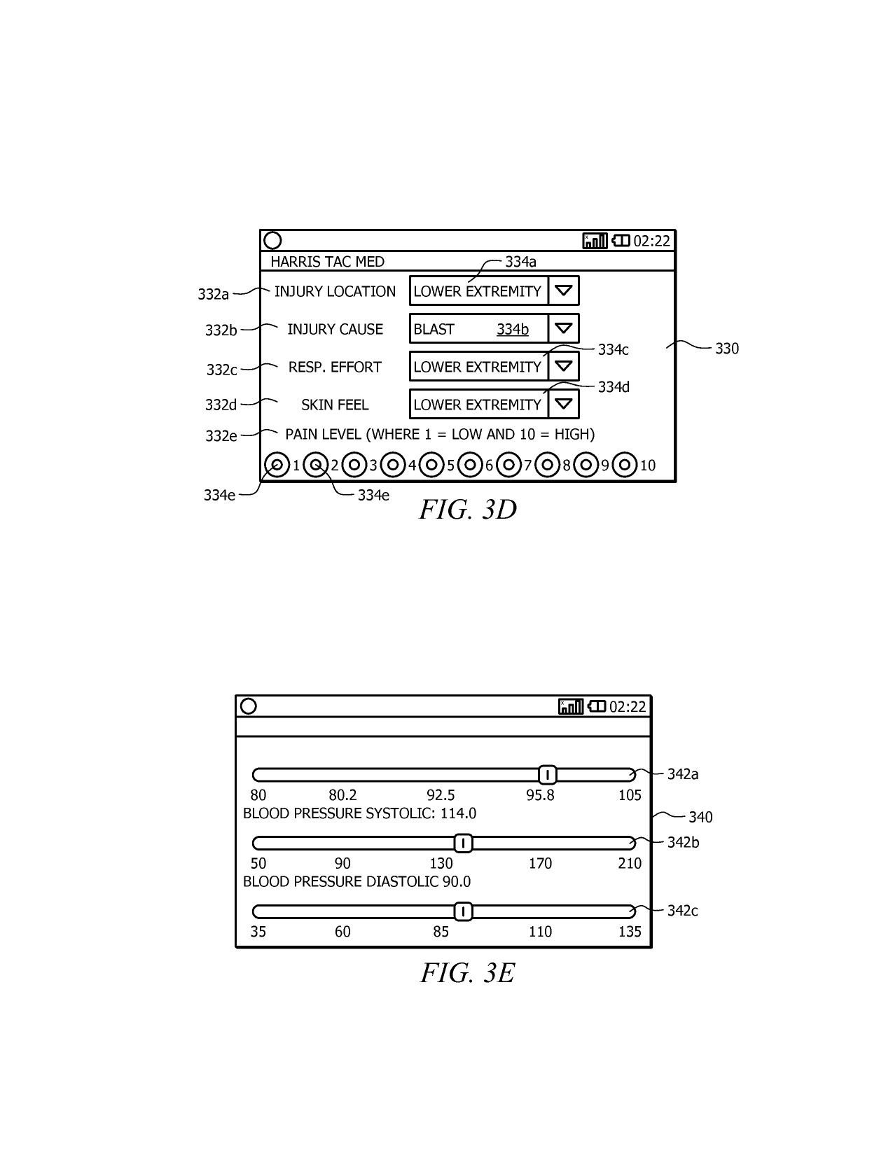

The tactical medical application 100 includes electronic medical record data creation module 130. As can be seen, the electronic medical records data creation module consists of an audio portion, a manually-entered data portion and an image portions. Audio module 132 is configured to facilitate the recording and storage of audio at 132a in response to user commands from the on-site medic. According to a preferred embodiment, this audio can include voice records of observations made by the medic. Collected audio can be also transcribed to text via the audio transcribe feature 132b and may be used to both enter commends to manipulate the application 100, select fields for data entry, as shown in the exemplary screen shots in FIG. 3, and to enter data into the fields.

A manual data entry module 134 facilitates manual data entry into an electronic medical record via the multi-touch screen display 115 or optical track pad 113. According to one embodiment, the electronic medical record form can be instantiated using a quick vital form module 134a, or a DD-1380 form module 134b. The quick vital form 134a is an abbreviated electronic form for selected vital signs of the warfighter and includes fields which would normally be found on the DD-1380 field medical card form 134b. Those skilled in the art will realize that the invention is not limited to these particular forms, and that the data entry modules can customized to be more appropriate for various other use scenarios.

Image capture module 136 is configured to facilitate the input of still images and/or video images. As such the image capture module can include an still image module 136a and a video module 136b. Still images can be used, for example, to show sites of injury on the warfighter and videos can be utilized, for example, to record the care given at the site of the injury.

Referring now to FIG. 2, there is shown a tactical triage device 200 and certain infrastructure which is advantageously used to communicate one or more electronic medical data records from device 200 to the TMDS. The tactical triage device 200, as previously discussed, is preferably a hand-held device such as a smartphone, dedicated hardware device or a computing pad. Tactical triage device 200 is configured so that it can be tethered either via a physical connection or a wireless connection to an entry point in a network. It is contemplated that the device will be able to utilize both tactical networks and commercially available networks, to move data.

As best understood with reference to FIG. 2, a tactical network utilizes a tactical radio 210a as the edge device. When used in this way, the tactical radio advantageously serves as an access point to tactical network 220. Tactical radio 210a provides the means of accessing the tactical network, which may consist of an encrypted core and encrypted or unencrypted edge devices. As such, the tactical radio 210a will provide a means for the real time movement of electronic medical data records from tactical triage device 200 to the TMDS system. In the tactical network 200 shown in FIG. 2, a tactical radio 210b is also used on the receiving end of the transmission and will receive the data and transfer it to an unencrypted computer 230 having access to the TMDS via a non-tactical network. Note that, in addition to any encryption which may be applied by the edge devices 210a and 210b, for transporting packets over tactical network 220, the electronic medial data record may itself be encrypted. Such encryption can advantageously preserve the privacy of the injured soldier, as a portion of the data communication path from theater to the TMDS database can be over a non-tactical, unencrypted network.

It is also contemplated that the electronic medical data record generated at the tactical triage device 200 may be uploaded from the device 200 directly to the TMDS database via a commercial network facility. Such a commercial network facility would likely provide an unencrypted path from the device to the TMDS system. In such a case, device 200 may be able to directly connect to a network using built-in WiFi, 3G or 4G LTE capability.

Referring once again to FIG. 1, tactical medical application 100 includes data transfer module 120. The data transfer module is advantageously configured to provide support for the movement of the electronic medical record from the device 200 to the TMDS system. The application 100 also provides capabilities for the movement of data via a tactical network or commercial IP network. In particular, these capabilities can be implemented in a tactical IP backbone communication module 122. The tactical IP backbone module 122 serves as a communication layer in the interface to the tactical radio 210a for the movement of data via a tactical network. Communications capabilities over a commercial IP network can be implemented in a commercial IP backbone communications module 124. The commercial IP backbone module 124 provides a secondary means of movement of the data, namely via commercially available IP networks. For example, such commercially available IP networks can include a WiFi, 3G or 4G LTE connection, as previously discussed. The data transfer module can include other communications modules and/or protocol layers. For example, in some embodiments, a data transport module can be included to facilitate a file transfer protocol (FTP) and/or chat function. The data transfer module 120 can also include a trusted network verification means, such as a CAC card.

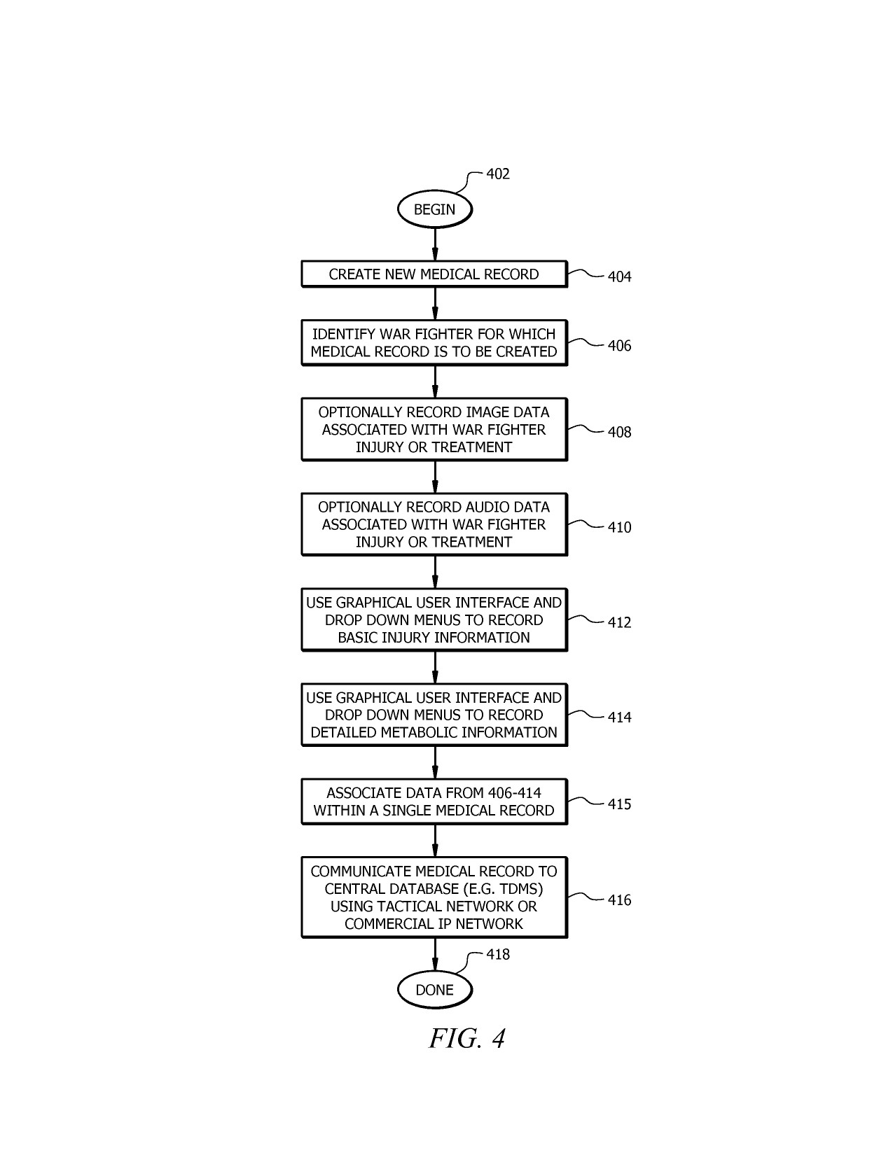

Referring now to FIG. 3A-3E, there are provided several views of the various sample screens of the tactical medical application 100. FIG. 4 is a flowchart that is useful for understanding a method for creating a medial record and shall be described in conjunction with the sample screens in FIGS. 3A-3E. The method is implemented by the tactical medical application 100 executing on the tactical triage device 200. The method begins in step 402 and continues with step 404. Step 404 involves creating a new medical record. A main screen 300 shown in FIG. 3A is arranged to facilitate the creation of the new medical record. The on-site medic can select either the quick vital form or the complete DD-1380 form by using the multi-touch screen display to activate button 301 or 302, respectively.

Medical data for the quick vital form or the complete DD-1380 form can be entered in several different ways. In one embodiment, an on-screen alpha-numeric keyboard can be used. However, in a preferred embodiment the device 200 includes a voice recognition component which is capable of converting human speech into recognizable text inputs and/or commands. The voice recognition component can be included within the application 100, but in other embodiments can be provided as part of a suite of software applications which execute on the tactical triage device. Voice recognition software applications are well known in the art and therefore will not be described here in detail. However, it should be understood that such voice recognition capability can advantageously facilitate entry of medical data concerning an injured person. For example, such data is advantageously entered by selecting various data input fields using a voice command. The voice command can be inputted to the device 200 via suitable audio interface hardware, such as a microphone, and allowing the input of data to these fields via a touch screen or via said microphone. Once the proper data field has been selected, the on-site medic can enter the necessary data using a voice command to select menu options and/or by means of a text to speech function provided by the voice recognition software.

A means to identify the warfighter must be provided. Such identification can be performed in step 406 by either selecting the soldier from an already-existing database or entering information. The identification information may be available from the warfighter's identification tags or identification card, and such data can be entered manually or via voice command. Alternatively, identification data can be entered by collecting an image of identifying subject matter. Such identifying subject matter can include an image of an identification tags, or an image of an identification card. Alternatively, an image of the injured person's face can be recorded with the tactical triage device 200. Thereafter, the facial image can be used to correlate the injured person with their medical record in the absence of other suitable information. A separate data entry screen (not shown) can be provided for manually entering such data when necessary. From the foregoing, it will be appreciated that main screen 300 provides means of entering data via image, including both still images and video, audio and screens to allow the entry of both a quick and a complete medical record.

The method can continue in optional step 408 with the selection of the image button 303 in screen 300 to initiate the recording of image data associated with the warfighter's injury or treatment. Screen 310 shows the means of inputting image data including, as previously stated, both still images and video. This capability can be used, for example, to provide images of particular injuries or to show a range of movement from the injured warfighter. The availability of this data back at a rear echelon care facility will allow the facility to be ready to accept and provide care for the specific type of injury sustained by the warfighter. Image data recorded in this way can include still and motion images. Such image data can be recorded using any well known image recording and/or compression scheme.

The method can also preferably include optional step 410 which advantageously involves selection of the audio button 304 in screen 300 to initiate the recording of audio data associated with the warfighter's injury or treatment. Referring now to screen 320 in FIG. 3C, there is shown an audio input screen that can be displayed when audio data is being recorded. Audio input capability provided in connection with screen 320 allows the entry of spoken records into the medical triage device 200. The medic can use this capability to describe injuries and to describe care which has already been provided, for example, medication records, pain relief administrations and any kind of special observations made by the medic during the initial treatment of the soldier. Audio data can be recorded using any known digital data recording and/or compression technique.

The method can continue in step 412 in which the on-site medic uses the graphical user interface of the tactical triage device 200 to optionally record injury information. Referring now to FIG. 3D, a graphical user input screen can be provide which facilitates entry of data relating to injuries. According to a preferred embodiment, the graphical user interface displays one or more prompts 332a-332e, menus 334a-334d and/or buttons 334e to facilitate entry of such injury information. For example, prompts 332a-332e can include an injury location, injury cause, respiratory effort, skin feel, and pain level. Menus can provide a quick selection of available inputs corresponding to the various prompts, and which can be quickly selected by the on-site medic. Of course more or fewer prompts and/or menus are also possible and the invention is not intended to be limited to those prompts and menus shown in FIG. 3D. Menu items are preferably selected in screen 330 by using touch screen inputs or voice commands. It will be appreciated that the data entry screen 330 facilitates allow the rapid creation of a quick medical record showing basic information about the injury including the location, the cause and the general overall condition of the warfighter.

The method can continue in step 414 in which the on-site medic uses the graphical user interface of the tactical triage device 200 to optionally record metabolic information. Referring now to FIG. 3E, it can be observed that screen 340 allows the entry of more specific metabolic information for the warfighter including heart rate, blood pressure and other vital signs. In a preferred embodiment, the screen 340 allows entry of such metabolic information by means of a graphical user interface. For example, a plurality of sliders 342a, 342b, 342c can be used to allow an on-site medic to quickly enter information concerning measurements of these important vital signs. The slider positions and any other user input menu items can be specified in screen 340 by using touch screen inputs or voice commands. It should be appreciated that more or fewer types of different metabolic information can be recorded using the application 100 running on tactical triage device 200, and the invention is not limited to those shown in FIG. 3E.

Once the on-site medic is done creating the electronic medical record, the method can continue in step 416 in which the application 100 associates the data collected in steps 406, 408, 410, 412, and 414 as part of a single or common medical record. In other words, the data is marked, indexed or stored in such a way that the data is identifiable as being part of a single common electronic medical record. For example, related data for a particular electronic medical record can be assigned a common index number, or can be stored in a predetermined way in a memory address, without limitation. Those skilled in the art will readily appreciate that there are many ways that the data collected can be associated as described herein and the invention is not intended to be limited to any particular association method. All that is necessary is for the data to be processed in such a way that it can be readily accessed as part of a single or common medical record for a particular injured warfighter. Step 416 in which all aspects of the record are uploaded via the previously discussed capability to the TMDS system, where it can be accessed by rear echelon care facilities such as battalion aid station.

In another aspect of the invention, medical records already existing in the TMDS system may be downloaded to device 200. This information may be invaluable in the treatment of an injured warfighter, and may provide information such as medical history, previous injuries, drug allergies, etc.

It should be realized that use of the described system need not be limited to application in a military theater or war. As previously discussed, the system could also be used by first responders in an urban setting, by doctors in an emergency room, or by nurses in a family practice setting to collect vital signs and record prescribed medications. Although medical records in these settings are not likely to be transmitted via a military tactical network, the requirements of data privacy imposed by HIPAA make it necessary to encrypt the transmission of personal medical records to a central storage facility via some means. In such cases, it is likely that medical records will be encrypted by any known means and transmitted via commercial IP networks.

The tactical triage device 200 will now be described in further detail. The system includes a central processing unit 534, a touch screen graphics processing unit (TSGPU) 517, a main memory 526 and a static memory 530, which communicate with each other via system bus 534. The TSGPU can include a capture interface 510 for capturing touch screen input data, a graphics processor 512 to facilitate display of data on the display unit screen (not shown) and a math calculating unit 513 which facilitates multi-touch screen inputs. A communications interface 515 can facilitate data communications from the TSGPU to the central processing unit 524 using interface bus 534.

The tactical triage device 200 can communicate with the TSGPU to facilitate the display of information, and for responding to user touch interaction as described herein with respect to FIGS. 1-3. To this end, the tactical triage device 200 can include an alpha-numeric input device 518 (e.g., a touch sensitive keyboard), a cursor control device such as a trackball. Suitable hardware is provided for collection of audio and image based data. For example, audio interface hardware 528 and imaging hardware 530 can be provided for this purpose. Network interface hardware 532 facilitates data communication operations described herein with respect to data transfer module 120.

A drive unit 520 includes a computer-readable storage medium 522 on which is stored one or more sets of instructions 524 (e.g., software code) configured to implement one or more of the methodologies, procedures, or functions described herein with respect to application 100. The instructions 524 can also reside, completely or at least partially, within the main memory 526, the static memory 530, and/or within the central processing unit 534 during execution thereof by the tactical triage device 200. The main memory 526 and the central processing unit 534 also can constitute machine-readable media.

Dedicated hardware implementations including, but not limited to, application-specific integrated circuits, programmable logic arrays, and other hardware devices can likewise be constructed to implement the certain methods described herein. Applications that can include the apparatus and systems of various embodiments broadly include a variety of electronic and computing devices as described herein. Thus, the exemplary system is applicable to software, firmware, and hardware implementations.

The term “computer-readable storage medium” shall be understood to include any medium that is capable of storing, encoding or carrying a set of instructions for execution by the machine and that cause the machine to perform any one or more of the methodologies of the present disclosure. The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical medium such as a disk or tape. Accordingly, the disclosure is considered to include any one or more of a computer-readable medium or a distribution medium, as listed herein and to include recognized equivalents and successor media, in which the software implementations herein are stored.

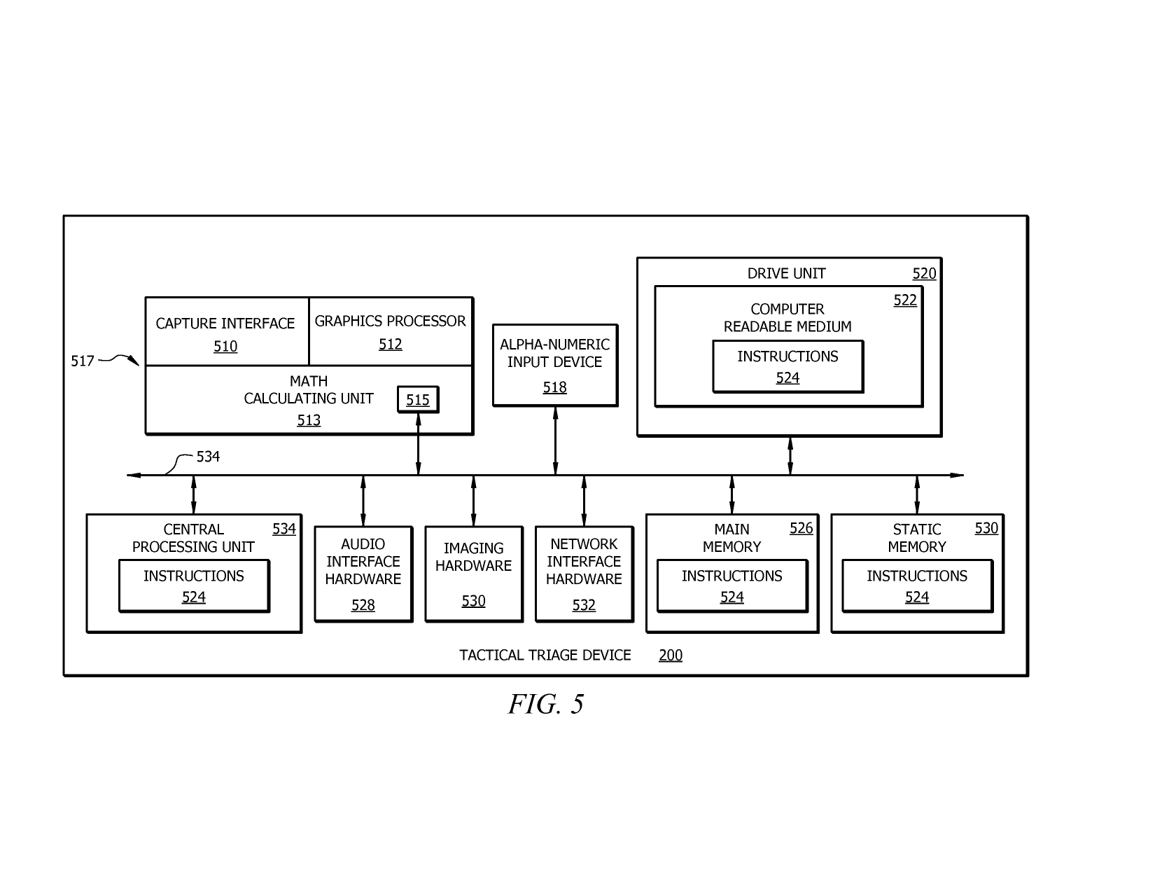

Those skilled in the art will appreciate that the device architecture illustrated in FIG. 5 is one possible example of a tactical triage device. However, the invention is not limited in this regard and any other suitable computing device architecture can also be used without limitation.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

We claim:

1. A method for creating an electronic medical record on a portable handheld computer from a field location to a remotely located central data facility, comprising:
receiving personal identification data for an injured person; responsive to a voice command entered via a microphone of said portable handheld computer, selecting a plurality of data input fields, and receiving input of data to these fields via a touch screen or via said microphone;
recording, with a camera included in said portable handheld computer, still or video imagery of said injured person;
recording, with said microphone, audio records containing information concerning injuries or treatments of said injured person;
forming an electronic medical record from said input data, said still or video imagery and said audio recordings; and
transmitting said electronic medical record over a communications network.

2. The method of claim 1, further comprising encrypting data contained in said electronic medical record prior to transmitting said medical record over said communication network.

3. The method of claim 1, further comprising establishing a data connection between said portable handheld computer and a tactical radio, and using said tactical radio as an access point to a tactical network for communicating said medical record.

4. The method of claim 3 wherein said data connection to said tactical radio is a wireless communication link.

5. The method of claim 1, wherein said communicating step further comprises communicating said electronic medical record using a wireless link with a commercial IP network.

6. The method of claim 5, wherein said communicating step further comprises communicating via a method selected from a group consisting of WiFi, 3G and 4G LTE.

7. The method of claim 1, wherein said electronic medical record is transmitted to a central database and stored therein.

8. The method of claim 1, further comprising receiving in said portable handheld computer an existing electronic medical record from a central medical database.

9. The method of claim 1, wherein said receiving personal identification data step includes receiving said data by a method selected from a group consisting of swiping a Common Access Card (CAC), manually entering the data on site and selecting the person from a pre-populated list of persons.

10. A system for providing an electronic medical record from a field location to a remotely located central data facility, said system comprising software, running on a portable computing device for performing the functions of:
receiving personal identification data for an injured person;
selecting, in response to a voice command, a one or more data input fields, and receiving input of data to said selected fields via a touch screen or via a microphone;
recording still or video imagery of said injured person via a camera;
recording audio records containing information concerning injuries or treatments of said injured person via a microphone;
forming an electronic medical record from said input data, said still or video imagery and said audio recordings; and
transmitting said electronic medical record over a communications network.

11. The system of claim 10, wherein said portable handheld computer is configured to encrypt data contained in said electronic medical record prior to transmitting said medical record over said communication network.

12. The system of claim 10, wherein said portable handheld computer is configured to establish a data connection between said portable handheld computer and a tactical radio, and use said tactical radio as an access point to a tactical network for communicating said medical record.

13. The system of claim 12 wherein said data connection to said tactical radio is selected from a group consisting of a wireless communication link and a USB connection.

14. The system of claim 10, wherein said portable handheld computer is configured to communicate said electronic medical record using a wireless link via a system selected from a group consisting of WiFi, 3G and 4G LTE.

15. The system of claim 10, wherein said portable handheld computer is configured to transmit said electronic medical record to a central database where said record is stored.

16. The system of claim 10, wherein said portable handheld computer is configured to receive an existing electronic medical record from a central medical database.

17. The system of claim 10, wherein said receiving personal identification data step includes receiving said data by a method selected from a group consisting of swiping a Common Access Card (CAC), manually entering the data on site and selecting the person from a pre-populated list of persons.

18. A non-transitory machine readable storage having stored thereon a computer program for providing an electronic medical record from a field location to a remotely located central data facility, said computer program executable by a portable handheld computer and comprising:
a personal identification data module for receiving personal information regarding for an injured person;
a data input module for selecting, one or more data input fields, and for receiving input of data to said selected fields;
an imagery module for recording still or video imagery of said injured person via a camera;
an audio module for recording audio records containing information concerning injuries or treatments of said injured person via a microphone;
a medical record module for forming an electronic medical record from said input data, said still or video imagery and said audio recordings; and
a transmission module for transmitting said electronic medical record over a communications network.

19. The computer program of claim 18 wherein said data input module can select data input fields and accept data for input into said selected fields via tactile or voice commands.
